(19) United States
(12) Patent Application Publication
(10) Pub. No.: US 2026/0165380 A1
(43) Pub. Date: Jun. 18, 2026

(54) HEATER FOR AN AEROSOL PROVISION DEVICE

(71) Applicant: Nicoventures Trading Limited, London (GB)

(72) Inventor: Juan Esteban Paz JAUREGUI, London (GB)

(21) Appl. No.: 19/125,273

(22) PCT Filed: Oct. 30, 2023
(86) PCT No.: PCT/EP2023/080283

§ 371 Date: Apr. 28, 2025

(30) Foreign Application Priority Data
Oct. 31, 2022 (GB) 2216150.9

(51) Int. Cl. A24F 40/46; A24F 40/70; H05B 3/06

(52) U.S. Cl. CPC A24F 40/46; A24F 40/70; H05B 3/06; H05B 2203/007; H05B 2203/017; H05B 2203/037

(57) ABSTRACT

A heater for an aerosol provision device comprising a housing; and a heater arrangement located in the housing. The heater arrangement comprises at least a first heating coil and a second heating coil, wherein the first heating coil and the second heating coil comprise resistive material. The heater arrangement further comprises an electrical input and an electrical output. A first end of the first heating coil and a first end of the second heating coil are electrically connected to the electrical input; and a second end of the first heating coil and a second end of the second heating coil are electrically connected to the electrical output.

### CROSS-REFERENCE TO RELATED APPLICATIONS

This present application is a National Phase entry of PCT Application No. PCT/EP2023/080283, filed 30 Oct. 2023, which claims priority from Great Britain Application No. 2216150.9, filed 31 Oct. 2022, each of which are fully incorporated herein by reference in their entireties.

### TECHNICAL FIELD

The present invention relates to a heater for an aerosol provision device, an aerosol provision device, an aerosol provision system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium. Separately induction heating systems are known to be used as heaters.

### SUMMARY

According to an aspect there is provided a heater for an aerosol provision device comprising:
a housing; and
a heater arrangement located in the housing, wherein the heater arrangement comprises at least a first heating coil and a second heating coil, wherein the first heating coil and the second heating coil comprise resistive material, and wherein the heater arrangement further comprises an electrical input and an electrical output;
wherein a first end of the first heating coil and a first end of the second heating coil are electrically connected to the electrical input; and
wherein a second end of the first heating coil and a second end of the second heating coil are electrically connected to the electrical output.

According to other embodiments the heating arrangement may more generally comprise a first resistive heating element and a second resistive heating element, wherein the first and second resistive heating elements are arranged in parallel. Accordingly, it is contemplated that there may be provided a heater for an aerosol provision device comprising a housing and a heater arrangement located in the housing, wherein the heater arrangement comprises at least a first resistive heating element and a second resistive heating element, wherein the first resistive heating element and the second resistive heating element comprise resistive material, and wherein the heater arrangement further comprises an electrical input and an electrical output. A first end of the first resistive heating element and a first end of the second resistive heating element may be electrically connected to the electrical input. A second end of the first resistive heating element and a second end of the second resistive heating element may be electrically connected to the electrical output.

The first heating coil and the second heating coil may be arranged in parallel.

Two or more discrete electrical paths may be formed between the electrical input and the electrical output.

The housing may comprise an inner cavity and wherein the heater arrangement is located within the inner cavity.

The inner cavity may be at least partially filled or substantially completely filled by the first heating coil, the second heating coil and a filler material.

The inner cavity may be at least partially filled or substantially completely filled by the first heating coil, the second heating coil, a filler material and either: (i) a portion of a first lead electrically connected to the electrical input; and/or (ii) a portion of a second lead electrically connected to the electrical output.

The filler material may be arranged to secure at least part of the heater arrangement in a fixed position relative to the housing.

The filler material may comprise one or more of: (i) a potting compound; (ii) an adhesive; (iii) a thermosetting plastic; or (iv) an epoxy resin.

The inner cavity may be at least partially filled with a thermally insulating material. The thermally insulating material may be a potting compound, an adhesive, thermosetting plastic or an epoxy resin. According to various embodiments the potting compound may comprise an epoxy resin. For example, a two-component epoxy may be used consisting of a polymer resin and a hardener which when mixed together causes a chemical reaction which cross-links chemical bonds in the polymer chains to create a tough, rigid and strong compound. Other embodiments are contemplated wherein the potting compound comprises a polyurethane (“PU”) e.g. a thermoset plastic. This may comprise a two-component compound consisting of a base resin with an isocyanate curing agent. Other embodiments are contemplated wherein the potting compound comprises a silicones. For example, silicone rubber may be utilised comprising a synthetic polysiloxane polymer that uses an additive catalyser (such as platinum) to transition from a liquid to a solid state.

The housing may comprise a metal or a metal alloy. For example, the housing may comprise aluminium or stainless steel. Alternatively, the housing may comprise a ceramic.

The first heating coil may be interlaced with the second heating coil.

At least a portion of the first heating coil may surround at least a portion of the second heating coil.

The first heating coil may have a first electrical resistance R1 and the second heating coil may have a second electrical resistance R2, wherein R1 and R2 are substantially the same. For example, R1 and R1 may differ by ≤10%, ≤9%, ≤8%, ≤7%, ≤6%, ≤5%, ≤4%, ≤3%, ≤2% or ≤1%.

The first heating coil may have an electrical resistance and/or a cross-sectional profile which is substantially constant along the length of the first heating coil. For example, the first heating coil may have an electrical resistance and/or a cross-sectional profile which is substantially constant along ≥90%, ≥91%, ≥92%, ≥93%, ≥94%, ≥95%, ≥96%, ≥97%, ≥98% or ≥99% of the length of the first heating coil.

The second heating coil may have an electrical resistance and/or a cross-sectional profile which is substantially constant along the length of the second heating coil. For example, the second heating coil may have an electrical resistance and/or a cross-sectional profile which is substantially constant along ≥90%, ≥91%, ≥92%, ≥93%, ≥94%, ≥95%, ≥96%, ≥97%, ≥98% or ≥99% of the length of the second heating coil.

The first heating coil may have a first electrical resistance R1 and the second heating coil may have a second electrical resistance R2, wherein R1 and R2 are substantially different. For example, R1 and R2 may differ by ≥10%, ≥20%, ≥30%, ≥40%, ≥50%, ≥60%, ≥70%, ≥80%, ≥90% or ≥100%.

The first heating coil may have an electrical resistance and/or a cross-sectional profile which is substantially different at two or more positions along the length of the first heating coil.

The second heating coil may have an electrical resistance and/or a cross-sectional profile which is substantially different at two or more positions along the length of the second heating coil.

The heater may comprise a resistive heating heater.

The first heating coil and the second heating coil may comprise resistive heating coils.

According to an aspect there is provided an aerosol provision device configured to heat an article comprising aerosol generating material, the device comprising a heater as described above.

The aerosol provision device may further comprise a DC voltage supply arranged to cause a DC current to pass via the electrical input, through the first heating coil and the second heating coil and then to pass via the electrical output.

According to an aspect there is provided a system comprising an aerosol provision device as described above and an article comprising aerosol generating material.

According to an aspect there is provided a method of generating an aerosol comprising:
providing an aerosol provision device as described above; and
at least partially inserting an aerosol generating article into a receiving portion of a heating chamber of the aerosol provision device.

The method may further comprise activating the aerosol provision device in order to generate aerosol from the aerosol generating article.

According to an aspect there is provided a method of manufacturing a heater for an aerosol provision device comprising:
providing a housing; and
locating a heater arrangement in the housing, wherein the heater arrangement comprises at least a first heating coil and a second heating coil, wherein the first heating coil and the second heating coil comprise resistive material, and wherein the heater arrangement further comprises an electrical input and an electrical output;
wherein a first end of the first heating coil and a first end of the second heating coil are electrically connected to the electrical input; and
wherein a second end of the first heating coil and a second end of the second heating coil are electrically connected to the electrical output.

According to various embodiments the housing may comprise an inner cavity and the method may further comprise at least partially filling any void remaining within the inner cavity once the heater arrangement has been located within the inner cavity with a filler material.

The heater may be a resistive heating heater. The heating member may be a resistive heating member. The heating element may be a resistive heating element. The coil may be a resistive heating heater coil.

The heater may be an inductive heating heater. The heating element may be an inductive heating element. The coil may be an inductive coil.

According to an aspect there is provided aerosol provision device configured to heat an article comprising aerosol generating material, the device comprising a heater as described above. The aerosol provision device may comprise a heating chamber, in which the heater is provided.

The aerosol provision device may comprise a power source, a controller and a heating chamber, in which the aerosol generating article is removeable received. The power source may be aligned along a longitudinal axis of the heating chamber. The power source may be aligned along a second longitudinal axis, parallel to the longitudinal axis of the heating chamber.

The aerosol provision device may be configured for wireless charging.

According to an aspect there is provided an aerosol provision system comprising: an aerosol provision device as described above; and an article comprising aerosol generating material.

The aerosol provision system may comprise a charging unit having a cavity for removably receiving the aerosol provision device. The charging unit may comprise a moveable lid, which covers the aerosol provision device in a closed configuration. The charging unit may comprise a user display. The user display may be visible to a user when the moveable lid is in a closed position and is partially or fully concealed or obscured from sight by the lid when the lid is an open position.

According to another aspect there is provided a method of generating aerosol comprising: providing an aerosol provision device as described above and at least partially inserting an aerosol generating article into the receiving portion of the heating chamber.

The method may further comprise energising the aerosol provision device in order to generate aerosol from the aerosol generating article.

### BRIEF DESCRIPTION OF THE DRAWINGS

Various embodiments will now be described, by way of example only, and with reference to the accompanying drawings, in which:

FIG. 1 shows a perspective view of an aerosol provision system including an aerosol provision device located within a charging unit;

FIG. 2 shows a schematic cross-sectional view of part of the aerosol provision device of FIG. 1;

FIG. 3 shows a schematic cross-sectional view of part of the aerosol provision device of FIG. 1 and an aerosol generating article of the aerosol provision system;

FIG. 4 Shows a Perspective View of Another Aerosol Provision Device;

FIG. 5 shows a schematic cross-sectional view of the device of FIG. 4;

FIG. 6 shows a schematic cross-sectional view of a heater of the device of FIG. 1 or FIG. 4;

FIG. 7 shows a schematic electrical diagram of a heating arrangement of a heater for an aerosol provision device according to various embodiments; and

FIG. 8 shows a schematic cross-sectional view of a heater of an aerosol provision device according to various embodiments wherein two heating coils are provided and wherein the two heating coils are provided in parallel.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the non-combustible aerosol provision device may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

As used herein, the term “aerosol-generating material” is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material. The sheet may be in the form of a wrapper, it may be gathered to form a gathered sheet or it may be shredded to form a shredded sheet. The shredded sheet may comprise one or more strands or strips of aerosol-generating material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales. The article may be, for example, of a predetermined or specific size that is configured to be placed within or over a heater of the device which is sized to receive the article.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The susceptor may be only magnetic, or only electrically-conductive. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

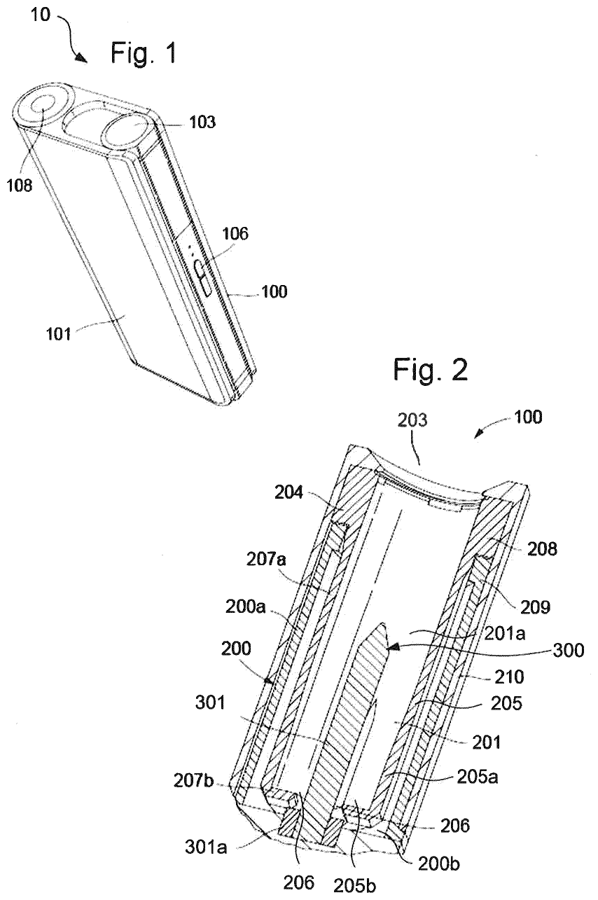

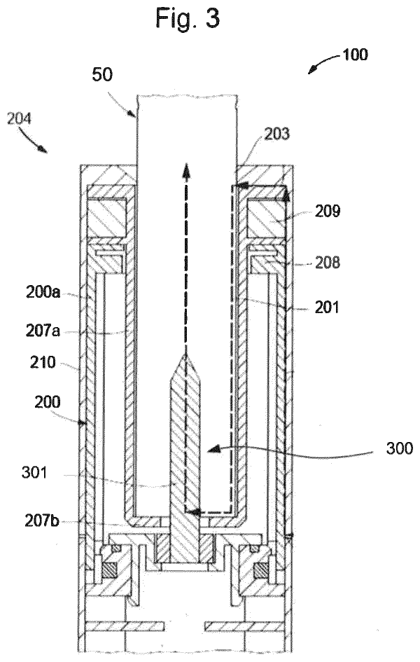

FIG. 1 shows an aerosol provision system 10 comprising an aerosol provision device 100 and a charging unit 101. The device is shown located within a cavity of a charging unit 101. The aerosol provision device 100 is arranged to generate aerosol from an aerosol generating article (refer to FIG. 3) which may be inserted, in use, into the aerosol provision device 100. In embodiments, the article forms part of the aerosol provision system 10.

The aerosol provision device 100 is an elongate structure, extending along a longitudinal axis. Additionally, the aerosol provision device has a proximal end, which will be closest to the user (e.g. the user's mouth) when in use by the user to inhale the aerosol generated by the aerosol provision device 100, as well as a distal end which will be furthest from the user when in use. The proximal end may also be referred to as the “mouth end”. The aerosol provision device 100 also accordingly defines a proximal direction, which is directed towards the user when in use. Further, the aerosol provision device 100 also likewise defines a distal direction, which is directed away from the user when in use. The terms proximal and distal as applied to features of the device 100 will be described by reference to the relative positioning of such features with respect to each other in a proximal-distal direction along a longitudinal axis. The aerosol provision device 100 comprises an opening at the distal end, leading into a heating chamber.

The aerosol provision device 100 may be removably inserted into the charging unit 101 in order to be charged. The charging unit 101 comprises a cavity for receiving the aerosol provision device 100. The aerosol provision device 100 may be inserted into the cavity via an opening. The cavity may also comprise a longitudinal opening. A portion of the aerosol provision device 100 may comprise a first side. One or more user-operable control elements such as buttons 106 which can be used to operate the aerosol provision device 100 may be provided on the first side of the aerosol provision device 100. The first side of the aerosol provision device 100 may be received in the longitudinal opening provided in the charging unit 101.

In embodiments the cavity of the charging unit 101 may have a cross-sectional profile which only permits that the aerosol provision device 100 be inserted into the charging unit 101 in a single orientation. According to an embodiment the outer profile of the aerosol provision device 100 may comprise an arcuate portion and a linear portion.

The cross-sectional profile of the cavity provided in the charging unit 101 may also comprise a similar arcuate portion and a linear portion. The linear portion of the cross-sectional profile of the cavity may correspond with the longitudinal opening.

The charging unit 101 includes a slidable lid 103. When the aerosol provision device 100 is inserted into the charging unit 101 in order to be recharged, the slidable lid 103 may be closed so as to cover the opening into the aerosol provision device 100. In other embodiments, the charging unit 101 may have an alternative lid configuration, such as a hinged or pivoted lid, or no lid may be provided.

The charging unit 101 may include a user interface such as display 108, which can be provided at any convenient location, such as in the position shown in FIG. 1.

FIG. 2 shows a cross sectional view of a portion of the aerosol provision device 100. The aerosol provision device 100 comprises a main housing 200. The main housing 200 defines a device body of the device 100. The device 100 defines a heating chamber 201. A receptacle 205 defines the heating chamber 201. An opening 203 is provided to provide access to the heating chamber 201. The receptacle 205 comprises a wall arrangement including a receptacle side wall 205a and a receptacle base 205b. The base 205b is at the distal end of the receptacle 205. A heating zone 201a is configured to receive at least a portion of the article for heating.

A heating member 301 is provided in a portion of the main housing 200 and the heating member 301 extends or projects into the heating chamber 201. The heating member 301 may comprise a base portion 301a which may be located in a recess provided in a portion of the body of the device 100. The heating member 301 upstands in the heating chamber 201. The heating member 301 upstands from the distal end.

The heating member 301 comprises an elongate heating member in the form of a pin. The pin may comprise a ceramic material. The heating member 301 in other embodiments comprises other elongate configurations, such as a blade. The heating member 301 may be inserted, in use, into a distal end of an aerosol generating article 50 (refer to FIG. 3) which is received within the heating chamber 201 in order to internally heat the aerosol generating article 50.

The housing comprises housing wall 200a. The housing wall 200a extends along the longitudinal axis of the aerosol provision device 100, surrounding the heating chamber 201. The housing wall 200a may, at least in part, define a receiving chamber of the aerosol provision device 100, as the volume which is enclosed within the wall 200a. A housing base 200b is at the distal end of the housing wall 200a. In the shown embodiment, the heating member 301 upstands from the housing base 200b. The heating member 301 protrudes through the receptacle base 205b. An aperture 206 is formed in the receptacle base 205b through which the heating member 301 protrudes. In embodiments, the heating member 301 is mounted to the receptacle base 205b. The heating member 301 upstands from the receptacle base 205b.

The aerosol provision device 100 further comprises a removal mechanism 204 which may be removably retained to the main housing 200 of the aerosol provision device 100. The removal mechanism 204 in embodiments is omitted. In embodiments, the housing wall 200a at least in part defines the receptacle 205. The removal mechanism 204 may be retained to the main housing 200 so that at least a portion of the removal mechanism 204 extends into the heating chamber 201. The removal mechanism 204 may comprise a longitudinal portion such as a peripheral wall portion 207a, which in the present embodiment is tubular, and a base wall portion 207b. The wall 207a may be a shape other than tubular, and may be any shape which encloses (e.g. encircles) and defines the heating chamber 201 there within.

In embodiments with the removal mechanism 204, the removal mechanism 204 defines the heating chamber 201. The removal mechanism 204 forms the receptacle 205. In embodiments in which the removal mechanism 204 is omitted, other features of the device 100 define the heating chamber 201, for example the housing side wall 200a and housing base 200b.

The base portion 207b has the aperture 206 through which the heating member 301 may project. In order to retain the removal mechanism 204 to the main housing 200, the removal mechanism 204 is pushed into engagement with the main housing 200 in the distal direction, i.e. towards the distal end of the main housing 200, until the removal mechanism 204 is able to move no further in the distal direction. In the following description, when the removal mechanism 204 is referred to as being “retained to” the main housing 200, this is when the removal mechanism 204 is engaged with the main housing 200, and can move no further in the distal direction.

Together, the peripheral portion 207a and the base portion 207b may define and enclose an article chamber for receiving, the aerosol generating article 50, as shown in FIG. 3. The article chamber comprises an inner surface, which is configured to contact the aerosol generating article, the inner surface comprising a longitudinally extending portion which is provided by the tubular portion 207a, and an end portion which is provided by the base portion 207b. In embodiments, the article chamber and the heating chamber are the same. When the aerosol generating article 50 is received in the heating chamber, it may contact both the longitudinally extending portion of the inner surface, and the end portion of the inner surface. In particular, the article chamber (i.e. the peripheral portion 207a and the base portion 207b) may be configured to receive at least part of the aerosol generating article 50 which is in the form of rod which is longitudinally extending and cylindrical, such that the longitudinal axis of the article is parallel to (and optionally in line with) the longitudinal axis of the aerosol provision device 100 when received in the article chamber.

The article chamber may also be referred to as a receiving portion. When the removal mechanism 204 is retained to the main housing 200, in use, the article chamber of the removal mechanism 204 is arranged, at least partially, within the heating chamber 201. The heating member 301 may be arranged so as to project into the article chamber, through the aperture 206 provided in the base portion 207b of the removal mechanism 204. The removal mechanism 204 is therefore configured to receive at least a portion of the aerosol generating article in use.

In embodiments, the removal mechanism 204 may comprise a first magnet or a magnetisable material 208. The main housing 200 may comprise a second magnet or magnetisable material 209. In use, the removal mechanism 204 may be magnetically retained to the main housing 200 by the interaction of the first magnet or magnetisable material 208 and the second magnet or magnetisable material 209.

In embodiments, the removal mechanism 204 is fully detachable from the main housing 200. The removal mechanism 204 may be retained to the main housing 200 by a magnetic force of attraction between the first magnet or magnetisable material 208 and the second magnet or magnetisable material 209. The removal mechanism 204 may be detached from the main housing 200 by overcoming the magnetic force between the first magnet or magnetisable material 208 and the second magnet or magnetisable material 209. In embodiments, the removal mechanism 204 is removably retained to the main housing 200 by other means. For example, the removal mechanism 204 may be configured to be removably retained to the main housing 200 by an interference fit with the main housing.

The removal mechanism 204 may comprise an internal element (comprising the tubular portion 207a and a base portion 207b) and an outer cap portion 210, wherein when retained to the main housing 200 the outer cap portion 210 encapsulates (e.g. covers) at least a portion of the main housing 200, such as the wall 200a of the main housing. The tubular portion 207a, base portion 207b and outer cap portion 210 may comprise an integral (e.g. unitary) component (formed, for example, by moulding). Alternatively, the tubular portion 207a and base portion 207b may comprise a first component and the outer cap portion 210 may comprise a second separate component. The first and second components may then be secured together.

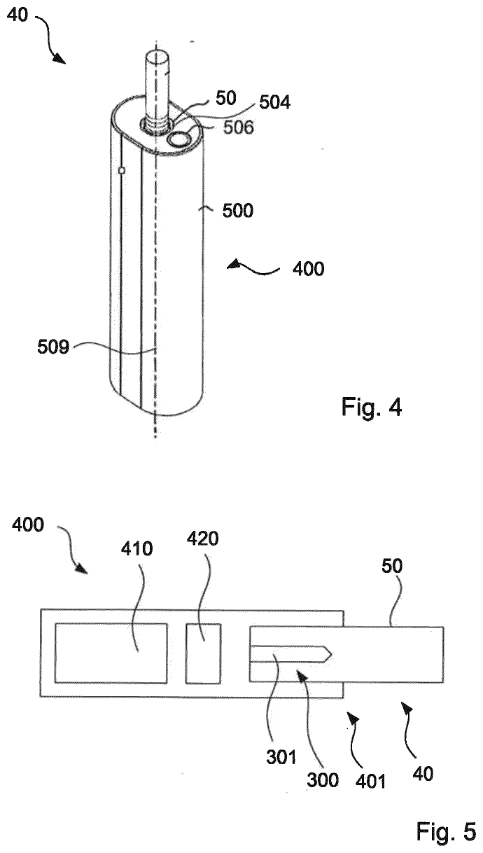

FIG. 4 shows another aerosol generating system 40. The system 40 comprises a one-piece aerosol generating device 400 for generating aerosol from an aerosol generating material, and the aerosol generating article 50 comprising the aerosol generating medium. The device 400 can be used to heat the aerosol generating article 50 comprising the aerosol generating medium, to generate an aerosol or other inhalable medium which can be inhaled by a user of the device 400.

The device 400 comprises a housing 500 which surrounds and houses various components of the device 400. The housing 500 is elongate. The device 400 has an opening 504 in one end, through which the article 50 can be inserted for heating by the device 400. The article 50 may be fully or partially inserted into the device 400 for heating by the device 400.

The device 400 may comprise a user-operable control element 506, such as a button or switch, which operates the device 400 when operated, e.g. pressed. For example, a user may activate the device 400 by pressing the switch 506.

The device 400 defines a longitudinal axis 509 along which an article 50 may extend when inserted into the device 400. The opening 504 is aligned on the longitudinal axis 509.

FIG. 5 shows a cross-sectional schematic view of the aerosol generating system 40. Features described with reference to FIG. 5 in embodiments are applicable to embodiments described above. The aerosol generating device comprises a power source 410, a controller 420 and a heating chamber 401, in which the aerosol generating article 50 is removeable received.

The one-piece device of FIG. 5 shows the power source 410 aligned along the longitudinal axis of the heating chamber 401. In another embodiment of a one-piece aerosol generating device, the power source is aligned along a second longitudinal axis, parallel to the longitudinal axis of the heating chamber.

The heating member 301 comprises an elongate heating member in the form of a pin. The heating member 301 in embodiments comprises other elongate configurations, such as a blade. The heating member 301 is provided in the heating chamber. The heating member 301 of FIG. 5 and the heating member 301 described above with reference to FIGS. 1 to 3, such that details described herein may be applied to each. The heating member 301 extends or projects into the heating chamber 401.

The heating member 301 may be inserted, in use, into a distal end of the aerosol generating article 50 which is received within the heating chamber 401 in order to internally heat the aerosol generating article 50.

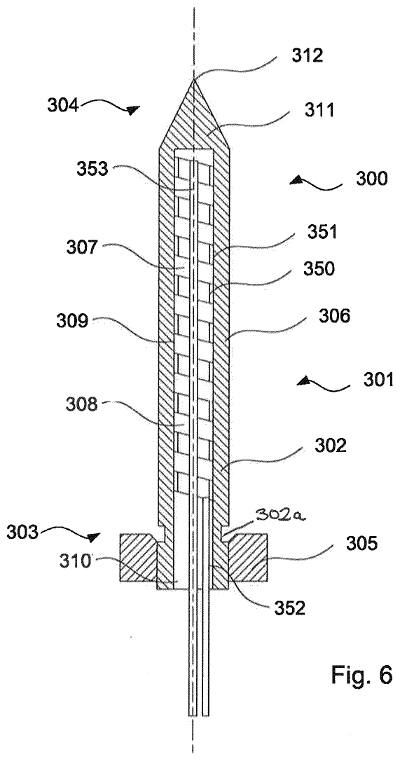

The aerosol provision devices 100, 400 comprise a heating arrangement 300. The heating arrangement 300 comprises a heater. The heating member 301 acts as the heater. The heater comprises a heating element 350 (refer to FIG. 6), such as a resistive heating coil, arranged to be actuated to heat the heating member 301.

The heating arrangement 300 is a resistive heating arrangement. The heater is a resistive heating heater. The heating element, such as a heating coil, as will be described below is a resistive heating element. In such arrangements the heating assembly comprises a resistive heating generator including components to heat the heating element via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement comprises electrical contacts for supplying electrical current to the resistive material. In embodiments, the heating element forms at least part of the resistive heating member itself. In embodiments the resistive heating element transfers heat to the heating member, for example by conduction. The provision of a resistive heating arrangement allows for a compact arrangement. Resistive heating provides an efficient configuration.

FIG. 6 shows the heating member 301 for use in an aerosol provision device as described above. The heating member 301 acts as or forms at least part of a heater. The heating arrangement 300 comprises the heating member 301. The heating member 301 comprises an elongate housing 302 and the heating element 350. The elongate housing 302 is an elongate member defining a longitudinal axis.

The elongate housing 302 is formed from a thermally conductive material, such as aluminium. Other suitable materials such as stainless steel or ceramic may be used. The elongate housing may comprise a coating on its outer surface. The elongate housing 302 is configured to transfer heat from the heating element 350 to the heating zone 201a.

The elongate housing 302 has a base end 303 and a free end 304. The base end 304 mounts to the device body. A mount 305 at the base end 303 mounts the heating member 301. It will be understood that different mounting arrangements may be used, for example a fixing, moulding and bonding including adhering. The mount 305 may be a separate component or may be integrally formed with the elongate housing 302.

A groove 302a or region of reduced cross sectional diameter may be provided in the elongate housing 302 towards the base end 303 of the elongate housing 302. As will be discussed in more detail below, a heating coil 351 is located within an inner void 308 of the heating member 301. The groove 302a or region of reduced cross sectional diameter may be located, for example, along the length of the elongate housing 302 at a longitudinal position which is intermediate a first longitudinal position corresponding to the longitudinal position of an end of the heating coil 351 closest to the base end 303 and a second longitudinal position corresponding to the longitudinal position where a base end of the elongate housing 302 attaches to, abuts or is otherwise secured to the mount 305.

It will be understood that the groove 302a or region of reduced cross sectional diameter reduces, restricts or diminishes the effect of heat conduction from the main body of the heating member 301 to the base end of the heating member 301 which is mounted to the mount 305. As a result, the flow of heat or thermal energy from the heating member 301 into the mount 305 is reduced. The groove 302a or region of reduced cross sectional diameter can therefore be considered as having the function of acting as a thermal break which reduces heat bleed from the heating member 301 into the mount 305 or more generally into a mounting point.

Further embodiments are contemplated (not shown) wherein more than one groove or region of reduced cross sectional diameter may be provided in the elongate housing to act as a thermal break. Although the groove 302a or region of reduced cross sectional diameter is shown in FIG. 6 as comprising an annular recess, wherein the annular recess has a rectangular cross-sectional profile, other embodiments are contemplated wherein the annular recess may have a different cross-sectional profile such as, for example, a V-notch or W-notch. Further embodiments are also contemplated wherein one or more grooves or regions of reduced cross sectional diameter may be provided on an inner surface of the elongate housing 302.

The elongate housing 302 comprises a housing body 306. The housing body 306 is tubular. The housing body 306 comprises a bore 307. The bore 307 defines an inner void 308 of the heating member 301. The inner void 308 extends longitudinally. In embodiments, the inner void 308 is at least partially filled, for example with a filler. In embodiments, the inner void 308 is completely filled, for example with one or more fillers and/or components. In embodiments, the inner void 308 defines an air gap. An inner surface 309 is defined on an inner side of the elongate housing 302. An open end 310 to the inner void 308 is provided at the base end 303.

The free end 304 of the elongate housing 302 extends towards the proximal end of the heating chamber. The free end 304 of the heating member 301 is closed. The inner void 308 does not extend through the free end 304. A tip 311 is provided at the free end 304. The tip 311 extends to an apex 312. Other shapes and configurations of the tip 311 may be provided, for example the tip 311 may define a planar surface.

The heating element 350 extends in the heating member 301. The heating element 350 extends in the elongate housing 302 in the longitudinal direction. The heating element 350 is received in the inner void 308. The heating element 350 extends between the base end 303 and the distal end 304. In embodiments, the heating element extends partially along the length of the inner void 308. In embodiments the heating element 350 extends to or beyond the open end 310.

The heating element 350 in embodiments comprises a heating coil 351. The heating coil 351 comprises a resistive member defining the heating coil 351. In embodiments the heating coil 351 comprises an electrically insulative coating, such as a ceramic, to electrically insulate the heating coil 351 from the elongate housing 302. The electrically insulative coating in embodiments is thermally conductive to provide for heat transfer from the heating element 350 to the elongate housing 302. In embodiments the electrically insulative coating is omitted. In embodiments, a separate electrically insulative arrangement, such as at least one of an electrically insulative member and an electrically insulative filler is provided. The electrically insulative member and electrically insulative filler in embodiments is thermally conductive to provide for heat transfer from the heating element 350 to the elongate housing 302.

The heating coil 351 is a resistive heating coil. The heating coil 351 is a helical coil. The heating coil 351 has a rectangular cross-sectional profile. It will be understood that other coil configurations are possible. In embodiments, the heating coil 351 has a circular cross-sectional profile. In embodiments, the heating arrangement 300 comprises two or more heating coils. In embodiments, the two or more heating coils are in a parallel array, or alternatively, a series array.

The heating arrangement 300 comprises electrical connection paths. The electrical connection paths extend from each end of the heating element 350. A base electrical connection path 352 extends from the distal end of the heating element 350. A return electrical connection path 353 extends from the proximal end of the heating element 350. The return electrical connection path overlaps the longitudinal extent of the heating element 350. The electrical connection paths 352,352 are integrally formed with the heating element 350, for example as a single wire. In embodiments, connectors connect the electrical connection paths 352,353 with the heating element 350. The heating coil 351 is formed from a resistive material, such as a nickel/chrome alloy such as nichrome 80/20(80 % nickel, 20% chromium), an iron/chrome/aluminium alloy, or a copper/nickel alloy.

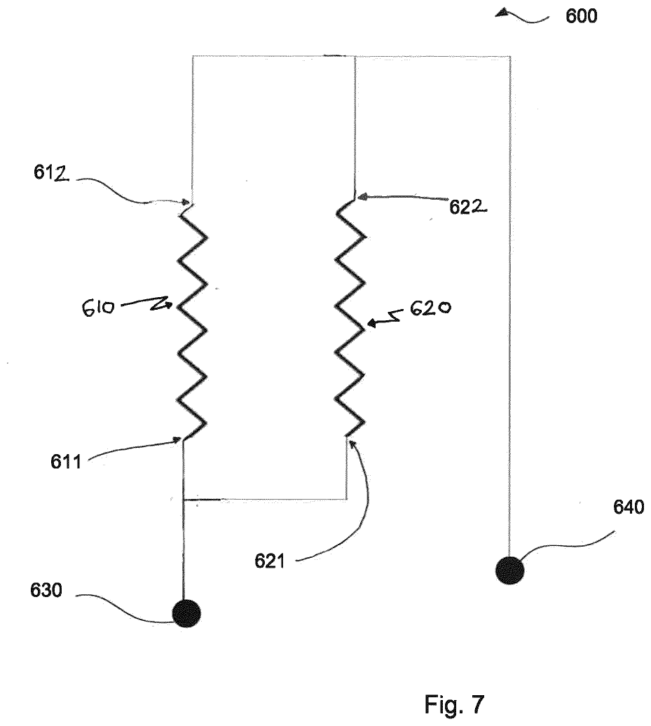

FIG. 7 shows a schematic electrical diagram of a heating arrangement 600 according to various embodiments. The heating arrangement 600 includes similar features to that of the heating arrangement 300 as described above with reference to FIG. 6 with the exception that the heating arrangement 600 comprises two heating coils 610,620 provided in parallel.

According to various embodiments there is provided a heater for an aerosol provision device. The aerosol provision device comprises a housing and a heater arrangement located in the housing. The heater arrangement may comprise at least a first heating coil 610 and a second heating coil 620. The first heating coil 610 and the second heating coil 620 may comprise resistive material. The heater arrangement may further comprise an electrical input and an electrical output. A first end of the first heating coil 610 and a first end of the second heating coil 620 may be electrically connected to the electrical input 630. A second end of the first heating coil 610 and a second end of the second heating coil 620 may be electrically connected to the electrical output 640.

It will be understood that if two electrical heating coils are provided in parallel then if the two heating coils have the same resistance R then the total resistance of the overall heating arrangement will be 0.5 R. As a result, for a fixed DC voltage supply, the total current supplied may be twice that if only a single heating coil were provided. As result, an increased current may be supplied to the heating arrangement compared to a heating arrangement comprising a single heating coil. This enables an article comprising aerosol generating material which is at least partially inserted into an aerosol provision device which incorporates the heater to be heated in a rapid manner.

Furthermore, providing two (or more) resistive heating coils 610,620 in parallel enables various bespoke heating arrangements to be provided. For example, the heating coils 610,620 may be interlaced and may have different resistances. As a result, a heater may be provided which has a heating profile which varies along the length of the housing which houses the heater arrangement.

According to various embodiments the heating arrangement comprising multiple resistive heating elements in parallel enables multiple flexible heating arrangements to be provided wherein numerous novel heating geometries may be provided.

In the embodiment illustrated in FIG. 7, the heating arrangement 600 includes a first heating coil 610 and a second heating coil 620. The first heating coil 610 and the second coil 620 act as resistive heaters i.e. the first heating coil 610 and the second heating coil 620 comprise resistive material. For example, first heating coil 610 and the second heating coil 620 may comprise a nickel/chrome alloy such as nichrome 80/20 (80% nickel, 20% chromium), an iron/chrome/aluminium alloy or a copper/nickel alloy.

It will be understood that the first heating coil 610 and the second heating coil 620 are located within a heating member 301 similar to the heating member 301 shown and described above with reference to FIG. 6.

The first heating coil 610 and/or the second heating coil 620 may comprise an electrically insulative coating, such as a ceramic, to electrically insulate the respective heating coil from an elongate housing 302 (as shown in FIG. 6). The electrically insulative coating may be thermally conductive in order to facilitate heat transfer from the first heating coil 610 and/or second heating coil 620 to the elongate housing 302. The electrically insulative coating prevents electrical shorting throughout the first heating coil's 610 and/or throughout the second heating coil's 620 entire length by e.g., electrically isolating turns of the respective coil that are next to one another. According to other embodiments no electrically insulative coating may be provided.

Embodiments are contemplated wherein a separate electrically insulative arrangement is provided comprising at least one of an electrically insulative member and an electrically insulative filler. The electrically insulative member and the electrically insulative filler may be thermally conductive in order to facilitate heat transfer from the first heating coil 610 and/or the second heating coil 620 to the elongate housing 302.

The first heating coil 610 and/or the second heating coil 620 may comprise helical coils. The first heating coil 610 and/or the second heating coil 620 may have a rectangular or substantially rectangular cross-sectional profile. It will be understood that other coil configurations are also contemplated, wherein for example, the first heating coil 610 and/or the second heating coil 620 may have a circular cross-sectional profile.

The first heating coil 610 and the second heating coil 620 are configured such that when an electrical current is directly applied to the coils 610,620, a resulting flow of current causes the first heating coil 610 and the second heating coil 620 to be heated by Joule heating.

The heating arrangement 600 further includes an electrical input 630 and an electrical output 640. According to various embodiment a DC electrical current is supplied to the electrical input 630 and then divides according to the relative resistances of the first heating coil 610 and the second heating coil 620. The electrical input 630 and/or the electrical output 640 may be connected to an electrical power source (not shown). For example, the electrical power source may comprise a rechargeable DC battery.

According to various embodiments the first heating coil 610 and/or the second heating coil 620 may have a resistance in the range 0.2-20 Ω. For example, the first heating coil 610 and/or the second heating coil 620 may have a resistance in the range 0.2-1 Ω, 1-5 Ω, 5-10 Ω, 10-15 Ω or 15-20 Ω. Other embodiments are contemplated wherein the first heating coil 610 and/or the second heating coil 620 may have a resistance <0.2 Ω or >20 Ω.

The rechargeable DC battery may comprise a lithium ion battery and may have a voltage of 4-5 V. According to an embodiment the DC battery may have a voltage of 4.2 V when fully charged. According to various embodiments the DC battery may be arranged to pass a current through the first heating coil 610 and the second heating coil 620 wherein the current passing through at least one or each of the heating coils 610,620 is in the range <0.1 A, 0.1-0.2 A, 0.2-0.3 A, 0.3-0.4 A, 0.4-0.5 A, 0.5-0.6 A, 0.6-0.7 A, 0.7-0.8 A, 0.8-0.9 A, 0.9-1.0 A or >1.0 A.

A first end 611 of the first heating coil 610 and a first end 621 of the second heating coil 620 are electrically connected the electrical input 630. A second end 612 of the first heating coil 610 and a second end 622 of the second heating coil 620 are electrically connected to the electrical output 640. According to various embodiments the first heating coil 610 and the second heating coil 620 are arranged in a parallel configuration so that electrical current supplied to the electrical input 630 passes in parallel (c.f. series) through both the first electrical heating coil 610 and the second electrical heating coil 620.

It will be understood that since the first electrical heating coil 610 and the second electrical heating coil 620 as provided in parallel then if the two heating coils have the same resistance R then the total resistance of the heating arrangement 600 comprising the two heating coils 610,620 will be 0.5 R. As a result, for a fixed DC voltage supply the total current supplied may be twice that if only a single heating coil 610; 620 were provided.

It will be appreciated, therefore, that the heating arrangement 600 according to various embodiments comprising two heating coils 610,620 in parallel enables an increased current to be supplied compared to a single heating coil. As a result, an article (not shown) may be heated quicker.

Furthermore, providing two (or more) resistive heating coils in parallel enables various bespoke heating arrangements to be provided. For example, the heating coils may be interlaced and may have different resistances. As a result, a heater may be provided which has a heating profile which varies along the length of the housing which houses the heater arrangement.

In use, an electrical current provided by e.g. a DC power source may be arranged to passed between the electrical input 630 and the electrical output 640. The resulting flow of current passes through both the first heating coil 610 and the second heating coil 620 causing the resistive material of the first heating coil 610 and the resistive material of the second heating coil 620 to be heated by Joule heating in a manner as described above.

The heat generated by the first heating coil 610 and the second heating coil 620 may be used to heat an aerosol generating article, such as an aerosol generating article as shown and described with reference to FIG. 3. According to various embodiments when an electrical current is passed between the electrical input 630 and the electrical output 630, the first heating coil 610 and the second heating coil 620 heat the elongate housing 302 (see FIG. 6). According to various embodiments the elongate housing 302 as shown in FIG. 6 may comprise a pin heater wherein an end of an aerosol generating article is inserted onto the pin heater. The pin heater may comprise a ceramic material. Accordingly, as the elongate housing 302 is heated by the first heating coil 610 and the second heating coil 620 the aerosol generating article is also heated and is caused to generate an aerosol.

With reference to FIG. 5, a power source 410 may be connected to or between the electrical input 630 and the electrical output 640. The power source 410 may, for example, comprise a DC voltage supply which is arranged to cause a DC current to pass via the electrical input 630, through the first heating coil 610 and the second heating coil 620 (in parallel) and then to pass via the electrical output 640.

Thus, a first discrete electrical path is formed between the electrical input 630, the first heating coil 610 and the electrical output 640, and a second discrete electrical path is formed between the electrical input 630, the second heating coil 620 and the electrical output 640.

According to various embodiments the first heater coil 610 and the second heating coil 620 may be interlaced with one another i.e. connected to the electrical input 630 and the electrical output 640 in a parallel configuration and forming a parallel circuit.

In embodiments, at least a portion of the first heating coil 610 may be arranged so as to surround at least a portion of the second heating coil 620 i.e. at least a portion first heating coil 610 and at least a portion the second heating coil 620 may overlap in the longitudinal direction of the elongate housing 302 of the heating member 301 (see FIG. 6).

It will be understood that whilst the embodiment shown and described with reference to FIG. 7 comprises a first and second heating coil 610,620, other embodiments are contemplated wherein the heating arrangement may comprise more than two heating coils. For example, other embodiments are contemplated wherein the heating arrangement 600 may comprise 3, 4, 5, 6, 7, 8, 9 or >10 heating coils. In other embodiments, first ends of each coil may be electrically connected to the electrical input 630, and second ends of the coils may be electrically connected to the electrical output 640. Thus, a plurality of discrete electrical paths in parallel may be formed.

Other embodiments are also contemplated wherein the heating arrangement 600 may more generally comprise a plurality of resistive heating elements which are arranged in parallel (c.f. series). The resistive heating elements may comprise heating coils or alternatively the resistive heating elements may be arranged differently from a coil whilst still providing a resistive heater.

According to various embodiments a plurality of heating coils may be provided, wherein two or more of the heating coils may be interlaced with one another, thereby forming a plurality of parallel traces, each forming part of the same parallel circuit.

The first heating coil 610 may have a first electrical resistance R1 and the second heating coil 620 may have a second electrical resistance R2. In some embodiments, R1 and R2 can be substantially the same. For example, R1 and R1 may differ by ≤10%, ≤9%, ≤8%, ≤7%, ≤6%, ≤5%, ≤4%, ≤3%, ≤2% or ≤1%. In other embodiments, R1 and R2 may be substantially different. For example, R1 and R2 may differ by ≥10%, ≥20%, ≥30%, ≥40%, ≥50%, ≥60%, ≥70%, ≥80%, ≥90% or ≥100%.

The first heating coil 610 may have an electrical resistance and/or a cross-sectional profile which is substantially constant along the length of the first heating coil 610. For example, the first heating coil 610 may have an electrical resistance and/or a cross-sectional profile which is substantially constant along ≥90%, ≥91%, ≥92%, ≥93%, ≥94%, ≥95%, ≥96%, ≥97%, ≥98% or ≥99% of the length of the first heating coil. Alternatively, the electrical resistance and/or cross-sectional profile can be substantially different at two or more positions along the length of the first heating coil 610.

The second heating coil 620 may have an electrical resistance and/or a cross-sectional profile which is substantially constant along the length of the second heating coil 620. For example, the second heating coil 620 may have an electrical resistance and/or a cross-sectional profile which is substantially constant along ≥90%, ≥91%, ≥92%, ≥93%, ≥94%, ≥95%, ≥96%, ≥97%, ≥98% or ≥99% of the length of the second heating coil 620. Alternatively, the electrical resistance and/or cross-sectional profile can be substantially different at two or more positions along the length of the second heating coil 620.

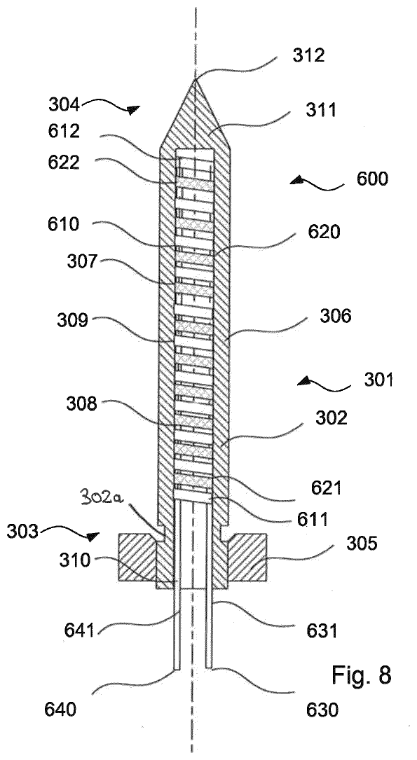

FIG. 8 shows a heating member 301 comprising a heating arrangement 600 according to various embodiments. The reference numerals correspond to the features having the same reference numerals described above with reference to FIGS. 6 and 7.

As described above with reference to FIG. 6, the elongate housing 302 comprises a housing body 306. The housing body 306 is tubular. The housing body 306 comprises a bore 307. The bore 307 defines an inner void 308 of the heating member 301. The inner void 308 extends longitudinally. The first heating coil 610 and second Copy heating coil 620 are disposed in the inner void 308 of the heating member 301.

A first heating coil 610 and a second heating coil 620 are arranged so as to extend in the heating member 301. The first heating coil 610 and the second heating coil 620 extend in the elongate housing 302 in the longitudinal direction. The first heating coil 610 and the second heating coil 620 extend between a base end 303 and a distal end 304 of the elongate housing 302. In embodiments, the first heating coil 610 and/or the second heating coil 620 extend partially along the length of the inner void 308. In embodiments the first heating coil 610 and/or the second heating coil 620 extend to or beyond the open end 310. According to various embodiments, the first heating coil 610 is interlaced with the second heating coil 620 and the two heating coils 610,620 are connected in parallel. Other coils (not shown) may also be provided and connected in parallel.

The inner void 308 of the elongate housing 302 may be at least partially filled or substantially completely filled by the first heating coil 610, the second heating coil 620 and a filler material (not shown).

The inner void 308 may be at least partially filled or substantially completely filled by the first heating coil 610, the second heating coil 620, a filler material and a portion of a first electrical connection path 631 electrically connected to an electrical input 630 and/or a portion of a second electrical path 641 electrically connected to an electrical output 640. Both the first and second electrical paths 631,641 may be connected to a DC power source (not shown).

The filler material may comprise one or more of: (i) a potting compound; (ii) an adhesive; (iii) a thermosetting plastic; or (iv) an epoxy resin. The filler material may be an electrically insulative material. The filler material can be used to secure at least part of the heater arrangement 600 in a fixed position relative to the housing 302 of the heater. In embodiments, the filler material may act to secure both the first heating coil 610 and the second heating coil 620 in a fixed position relative to the elongate housing 302. The filler may be thermally conductive to facilitate heat transfer from the first and second heating coils 610,620 to heat the heating member 301.

The inner cavity 308 may be at least partially filled with a thermally insulating material. The thermally insulating material may be a potting compound, an adhesive, thermosetting plastic or an epoxy resin. According to various embodiments the potting compound may comprise an epoxy resin. For example, a two-component epoxy may be used consisting of a polymer resin and a hardener which when mixed together causes a chemical reaction which cross-links chemical bonds in the polymer chains to create a tough, rigid and strong compound. Other embodiments are contemplated wherein the potting compound comprises a polyurethane (“PU”) e.g. a thermoset plastic. This may comprise a two-component compound consisting of a base resin with an isocyanate curing agent. Other embodiments are contemplated wherein the potting compound comprises a silicones. For example, silicone rubber may be utilised comprising a synthetic polysiloxane polymer that uses an additive catalyser (such as platinum) to transition from a liquid to a solid state.

As described above, the heating arrangement 600 may comprise a first electrical connection path 631 and a second electrical connection path 641. The first electrical connection path 631 connects between an electrical input 630 and both a first end 611 of the first heating coil 610 and a first end 621 of the second heating coil 620. The second (return) electrical connection path 641 may extend from a second end 612 of the first heating coil 610 and a second end 622 of the second heating coil 620 and connects to an electrical output 640.

The second (return) electrical connection path 641 may overlap the longitudinal extent of the heating member 301. The second electrical connection path 641 may terminate at the electrical output 640. The first and second electrical connection paths 631,641 may be formed integrally formed with the heating member 301 as a wire or other connector. In embodiments, connectors may connect the first and second electrical connection paths 631,641 to the first heating coil 610 and the second heating coil 620.

In the above described embodiments, the heating arrangement is a resistive heating arrangement. In embodiments, other types of heating arrangement are used, such as inductive heating. The configuration of the device is generally as described above and so a detailed description will be omitted.

An inductive heating arrangement comprises various components to heat the aerosol generating material of the article via an inductive heating process. Induction heating is a process of heating an electrically conducting heating member (such as a susceptor) by electromagnetic induction. An induction heating arrangement may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating member) suitably positioned with respect to the inductive element. In inductive heating, as compared to heating by conduction for example, heat is generated inside the susceptor, allowing for rapid heating. Further, there need not be any physical contact between the inductive element and the susceptor, allowing for enhanced freedom in construction and application.

In inductive heating heat is generated in the susceptor (heating member) whereas in resistive heating heat is generated in the coil (heating element).

In embodiments, the heating member of the aerosol provision system is a part of the aerosol generating article, rather than being a part of the aerosol provision device. The heating element may be a resistive heating element, for example in the form of the resistive coil described above, which is provided as part of the aerosol generating article. Electrical connections may enable electric current to flow through the resistive heating element.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A heater for an aerosol provision device comprising:
a housing; and
a heater arrangement located in the housing, wherein the heater arrangement comprises at least a first heating coil and a second heating coil, wherein the first heating coil and the second heating coil comprise resistive material, and wherein the heater arrangement further comprises an electrical input and an electrical output;
wherein a first end of the first heating coil and a first end of the second heating coil are electrically connected to the electrical input; and
wherein a second end of the first heating coil and a second end of the second heating coil are electrically connected to the electrical output.

2. The heater of claim 1, wherein the first heating coil and the second heating coil are arranged in parallel.

3. The heater of claim 2, wherein two or more discrete electrical paths are formed between the electrical input and the electrical output.

4. The heater of claim 1, wherein the housing comprises an inner cavity and wherein the heater arrangement is located within the inner cavity.

5. The heater of claim 4, wherein the inner cavity is at least partially filled or substantially completely filled by the first heating coil, the second heating coil and a filler material.

6. The heater of claim 4, wherein the inner cavity is at least partially filled or substantially completely filled by the first heating coil, the second heating coil, a filler material and either: (i) a portion of a first lead electrically connected to the electrical input; and/or (ii) a portion of a second lead electrically connected to the electrical output.

7. (canceled)

8. (canceled)

9. The heater of claim 1, wherein the housing comprises a metal or a metal alloy.

10. The heater of claim 1, wherein the first heating coil is interlaced with the second heating coil.

11. The heater of claim 1, wherein at least a portion of the first heating coil surrounds at least a portion of the second heating coil.

12. The heater of claim 1, wherein the first heating coil has a first electrical resistance R1 and the second heating coil has a second electrical resistance R2, wherein R1 and R2 are substantially the same.

13. The heater of claim 1, wherein the first heating coil has an electrical resistance and/or a cross-sectional profile which is substantially constant along the length of the first heating coil.

14. The heater of claim 1, wherein the second heating coil has an electrical resistance and/or a cross-sectional profile which is substantially constant along the length of the second heating coil.

15. The heater of claim 1, wherein the first heating coil has a first electrical resistance R1 and the second heating coil has a second electrical resistance R2, wherein R1 and R2 are substantially different.

16. The heater of claim 1, wherein the first heating coil has an electrical resistance and/or a cross-sectional profile which is substantially different at two or more positions along the length of the first heating coil.

17. The heater of claim 1, wherein the second heating coil has an electrical resistance and/or a cross-sectional profile which is substantially different at two or more positions along the length of the second heating coil.

18. (canceled)

19. The heater of claim 1, wherein the first heating coil and the second heating coil comprise resistive heating coils.

20. An aerosol provision device configured to heat an article comprising aerosol generating material, the device comprising a heater as claimed in claim 1.

21. A system comprising the aerosol provision device according to claim 20 and an article comprising aerosol generating material.

22. A method of generating an aerosol comprising:
providing an aerosol provision device as claimed in claim 20; and
at least partially inserting an aerosol generating article into a receiving portion of a heating chamber of the aerosol provision device.

23. (canceled)

24. A method of manufacturing a heater for an aerosol provision device comprising:
providing a housing; and
locating a heater arrangement in the housing, wherein the heater arrangement comprises at least a first heating coil and a second heating coil, wherein the first heating coil and the second heating coil comprise resistive material, and wherein the heater arrangement further comprises an electrical input and an electrical output;
wherein a first end of the first heating coil and a first end of the second heating coil are electrically connected to the electrical input; and
wherein a second end of the first heating coil and a second end of the second heating coil are electrically connected to the electrical output.
